(19) United States
(12) Patent Application Publication
(10) Pub. No.: US 2002/0191801 A1
(43) Pub. Date: Dec. 19, 2002

(54) Device for aiding the process of memorization

(76) Inventor: Jose Lopez, Pacifica, CA (US)

Correspondence Address: JOSE LOPEZ, 116 DEL MONTE DRIVE, PACIFICA, CA, 94044, US

(21) Appl. No.: 09/883,170

(22) Filed: Jun. 18, 2001

(51) Int. Cl. H04B 3/00

(52) U.S. Cl. 381/77

(57) ABSTRACT

Device for aiding the process of memorization comprising; a portable housing made of plastic or other rigid material, the housing containing a microprocessor and digital memory and associated electronic components that are designed to achieve the features necessary for creating a digital memorization aid, a speaker, a volume control, a microphone, a battery power source, a Record/Play switch, a Rewind switch, a Forward switch, a Start/Stop switch, a Temporary Erase switch, a Permanent Erase switch, a Question Number display, a Memory use display, an On/Off switch, a Headphone jack, an AC adaptor jack, and a digital line output jack. A preferred embodiment includes wherein said memorization aid allows a user to quickly skip over questions and answers that are known to play questions and answers that are not known.

### BACKGROUND OF THE INVENTION

This invention relates generally to the field of digital audio recording devices, and more particularly to a digital audio recording device for aiding the process of memorization.

It is common for students to have to memorize information so that they can pass a test or simply retain the information for use at a later time. Typical information to be memorized includes historical facts and dates, mathematical formulas, technical terms and processes and the like.

Various methods of memorizing exist. One method is to simply read and review the information over and over again until the information is firmly established in the memory portion of the brain. A more effective alternative is to record questions into a recording device such as a tape recorder and then record the answer. The user can then play back the questions and try to remember the answers. The user can then play back the answer to see if he or she is correct. This process approximates what can be expected in a test environment and can better prepare the student for taking a test. There are however, a number of problems that occur when using a standard tape recorder or other digital recording device for the purpose of a memorization aid. First, the user can not easily and quickly pass over questions that her or she may know to reach the question that he or she may not know. Second, the user can not easily see what number question he or she is on, or which question he or she would like to skip to. Finally, there is no way for a person to temporarily erase a question and then to bring the question back when needed at a later time.

### SUMMARY OF THE INVENTION

The primary object of the invention is to provide a digital audio device that aids in the process of memorization.

Another object of the invention is to provide a memorization aid device that allows a user to digitally record questions and answers to questions and then to play back questions and answers.

Another object of the invention is to provide a memorization aid device that visually indicates each question number.

A further object of the invention is to provide a memorization aid device that allows the user to skip ahead or back to a desired question and answer.

Yet another object of the invention is to provide a memorization aid device that allows the user to temporarily erase a question and answer set and to be able to retrieve said question and answer when necessary.

Still yet another object of the invention is to provide a memorization aid device that allows the user to erase all questions and answers when necessary.

Another object of the invention is to provide a memorization aid device that allows the user to export all recorded information into another memory receptacle such as a digital memory card, CD rom, audio tape or the like.

Another object of the invention is to provide a memorization aid device that is portable and battery operated.

A further object of the invention is to provide a memorization aid device that provides a jack for headphone use.

Yet another object of the invention is to provide a memorization aid device that incorporates a visual display that shows amount of memory left.

Still yet another object of the invention is to provide a memorization aid device that incorporates a low battery light.

Another object of the invention is to provide a memorization aid device that incorporates a jack for an AC adaptor.

Another object of the invention is to provide a memorization aid device that includes a belt clip for hands free operation.

A further object of the invention is to provide a system for using said memorization aid device to the users maximum advantage.

Other objects and advantages of the present invention will become apparent from the following descriptions, taken in connection with the accompanying drawings, wherein, by way of illustration and example, an embodiment of the present invention is disclosed.

Device for aiding the process of memorization comprising: A portable housing made of plastic or other rigid material, said housing containing a microprocessor, a memory chip and associated electronic components that are designed to achieve the features necessary for creating a digital memorization aid, a speaker, a volume control, a microphone, a battery power source, a Record/Play switch, a Rewind switch, a Forward switch, a Start/Stop switch, a Temporary Erase switch, a Permanent Erase switch, a Question Number display, a Memory use display, an On/Off switch, a Headphone jack, an AC adaptor jack, and a digital line output jack. The present invention allows a user to quickly advance through questions and answerers that her or she has pre-recorded. The question number is shown on a display. The user can also temporarily delete questions and answers that he or she knows the answers to and then retrieve them at a later time.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a front view of the memorization aid device of the present invention.

FIG. 2 is a side view of the memorization aid device of the present invention.

FIG. 3 is a rear view of the memorization aid device of the present invention.

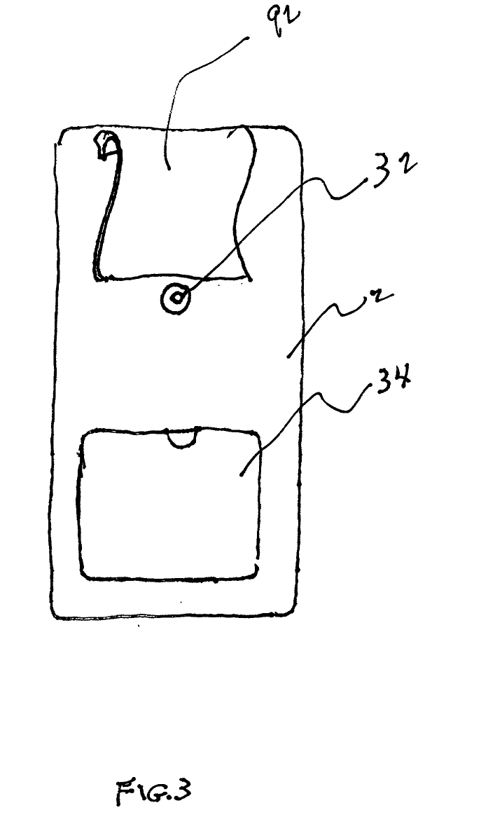

FIG. 4 is a schematic drawing of the circuit used in the present invention.

FIG. 5 is a flow chart showing to sequence of use of the present invention.

FIG. 6 is a front view of the memorization aid device showing an alternate embodiment that includes a removable memory card.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

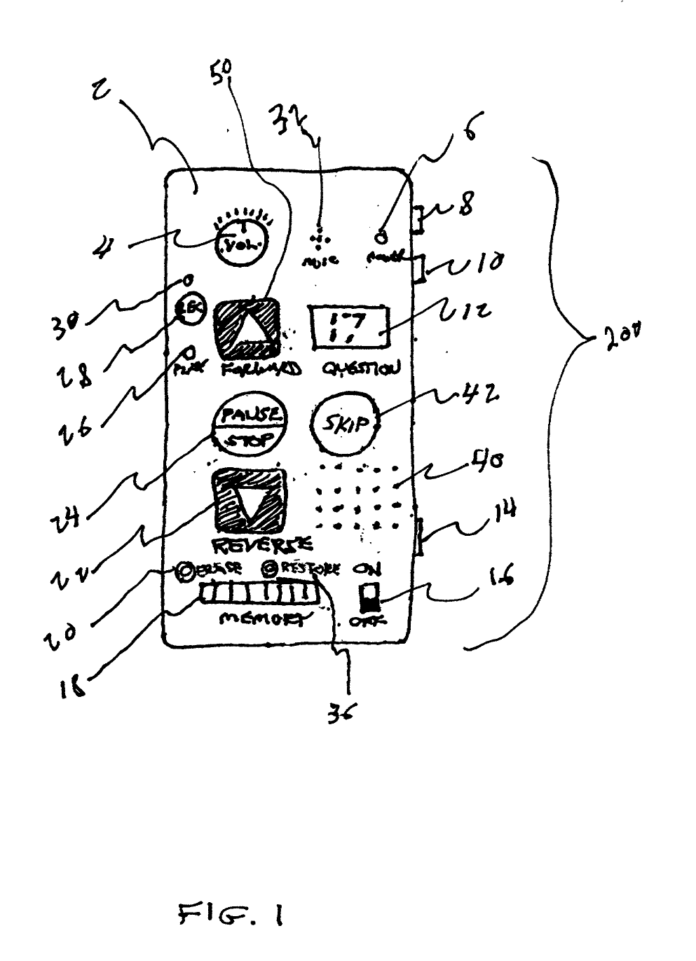

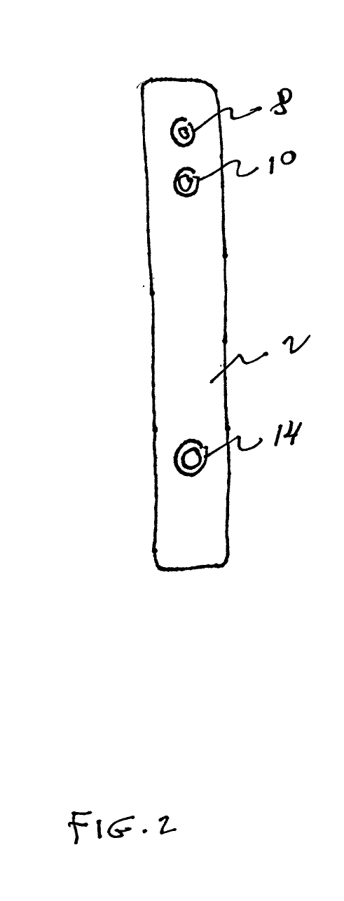

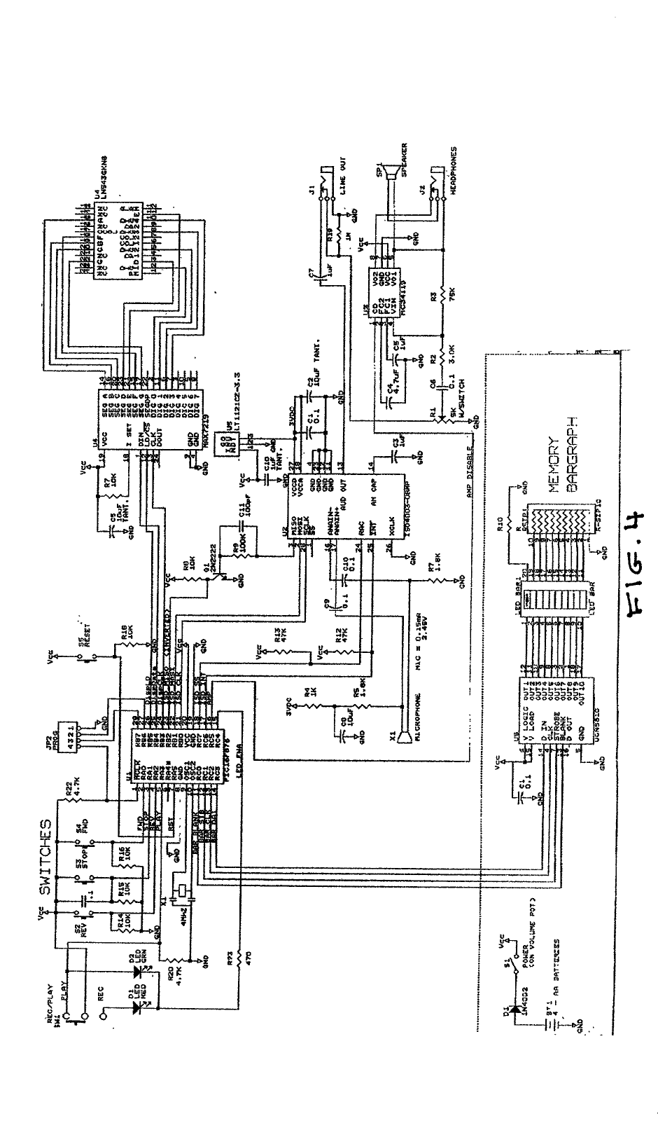

The present invention is a device that is meant to help a person to memorize material. Referring to FIG. 1 we see a front view of the present intention. The device shown is meant to be hand held The housing 2 is approximately two and one half inches wide, five inches tall and one inch thick. The front panel 200 provides most of the control and indicating portions these include: volume control 4, microphone 32, power indicating light 6, record light indicator 30, record and un-record switch 28, play light indicator, Forward switch 50, pause switch 24, reverse switch 22, temporary erase switch 20, restore switch 36, memory light indicator 18, on-off switch 16, speaker 40, skip switch 42 and question number LCD display 12. The side panel of housing 2 shown in FIG. 2 includes headphone out jack 8, information out jack 10 and AC/DC adaptor jack. The rear panel of housing 2 shown in FIG. three includes battery door 34 and erase all switch 32 and belt clip 92. FIG. 4 is a schematic view of the circuit of the present invention.

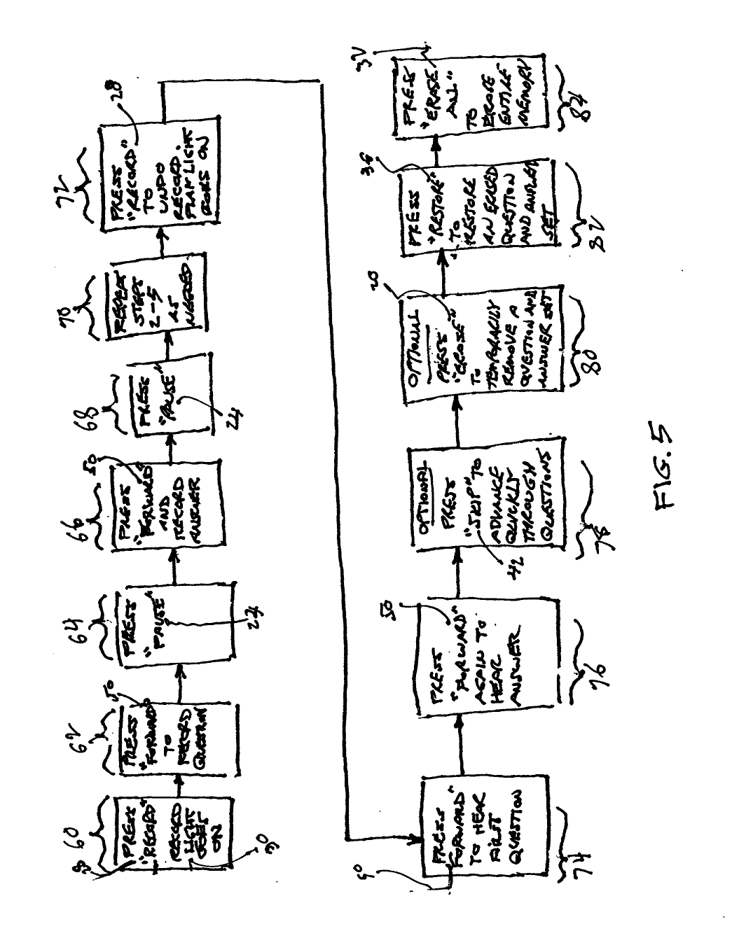

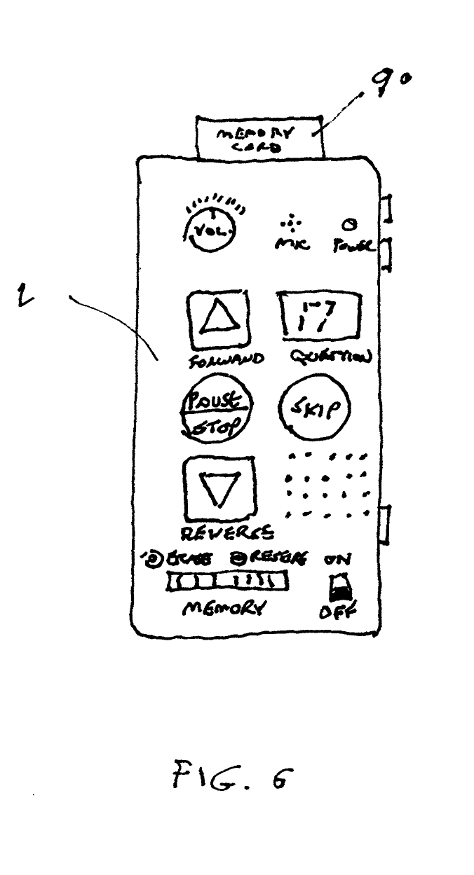

FIG. 5 shows a flow chart that explains the operation and use of the present memorization aid device. After turning on the device with switch 16, the user proceeds to the first step 60 where the user presses the Record button 28. The record light 30 goes on indicating that the device is ready to record question and answer sets. In the next step 62 the user presses the Forward button 50 and records a question to the information to be memorized. For example, if the information is historical in nature, the question might be “when was the declaration of independence signed?”. The number “1” then shows up in the “question number LCD display 12. In the next step 64, the user presses the pause 24 button thereby stopping the recording process temporarily. In the next step 66 the user presses the forward 50 button again and records the answer, which in this case would be “Jul. 4, 1776”. The user would then continue to record questions and answers as indicated in step 70. When all the questions and answers are recorded the user then presses the Record 28 button to undo the recording function thereby turning off the record light 30 and turning on the play light 26 as shown in step 72. When the user wants to test himself regarding the information stored in the present memorization aid device he or she presses the forward 50 button to hear the first question which can be heard from internal speaker 40, or through optional headphones that can be attached to headphone jack 8 as shown in step 74. The device will stop after the question is asked. The users then attempts to answer the question from memory. To hear the answer the user presses the forward 50 and the answer is played back as shown in step 76. This process of playing back question and answers can be continued until the person memorizes the information stored in the memory aid device. As the user learns answers to questions, he or she can advance quickly through questions and answers by pressing the skip 42 button as shown in step 78. The user can skip backwards by first pressing the Reverse button 22. When the user feels that he or she has memorized the answer to a certain question, her or she can temporarily erase the question and answer set by pressing the erase button 20 as shown in step 80. If the user needs to restore the question and answer set that has been erased, her or she can go the question and answer set desired which is indicated by the “Question Number” LCD display 12 and press the Restore 36 button as shown in step 82. The amount of memory left in the internal digital memory storage area is indicated by segmented LED display 18. As the memory fills up, more and more lit egments of display 18 appear. When the user is finished with memorizing all the information recorded in the present memorization aid device invention, he or she can erase all the information by pressing the Erase All button 32 on the back of the housing 2. Optionally, the use can store the question and answer information in another memory storage device such as a tape recorder, computer, digital recorder or the like by plugging in a line out cord into jack 10 shown in FIG. 2. FIG. 6 shows an alternate embodiment where a memory card 90 can be removably inserted into the top of housing 2. When the user is finished memorizing the question and answer sets the user can remove the memory card 90 which can be re-inserted at a future date for refreshing ones memory. Additionally, pre-recorded memory cards can be provided by an educational materials distribution company thereby eliminating the need for the user to personally record answers and questions. The user can power the memorization aid of the present invention by battery, inserting batteries into battery door 34, or by attaching an AC to DC adaptor into input jack 14.

In the above described and illustrated way, a person can record and playback questions and answers in a quick and efficient way so that the person can memorize material and test himself on the material in the most efficient manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Device for aiding the process of memorization comprising:
A portable housing made of plastic or other rigid material, said housing containing;
a microprocessor, a memory storage chip and associated electronic components that are designed to achieve the features necessary for creating a digital memorization aid including;
a speaker;
a volume control;
a microphone;
a battery power source;
a Record/Play switch;
a Rewind switch;
a Forward switch;
a Start/Stop switch;
a Temporary Erase switch;
a Permanent Erase switch;
a Question Number display;
a Memory use display;
an On/Off switch;
a Headphone jack;
an AC adaptor jack; and
a digital line output jack.

2. Device for aiding the process of memorization as claimed in claim 1 wherein said memorization aid allows a user to quickly skip over questions and answers that are known to questions and answers that are not known.

3. Device for aiding the process of memorization as claimed in claim 1 wherein said user can temporarily erase a question and answer set, and then retrieve said question and answer set when needed.

4. Device for aiding the process of memorization as claimed in claim 1 wherein said user can see by said Question Number display, which question he or she is on.

5. Device for aiding the process of memorization as claimed in claim 1 wherein said user can see by means of said Memory use display, how much memory is left within said microprocessor.

6. Device for aiding the process of memorization as claimed in claim 1 wherein said can operate said portable unit by battery power or by AC line voltage.

7. Alternate embodiment of the present invention wherein a removable replacable memory card can be inserted into the device to store answers and questions.
